(19) United States
(12) Patent Application Publication
(10) Pub. No.: US 2011/0005869 A1
(43) Pub. Date: Jan. 13, 2011

(54) Method and Apparatus of Space Elevators

(76) Inventor: Gaylen R. Hinton, Durham, NC (US)

Correspondence Address: Gaylen Hinton, 3519 Cottonwood Dr., Durham, NC, 27707, US

(21) Appl. No.: 12/501,838

(22) Filed: Jul. 13, 2009

(51) Int. Cl. B66B 7/00

(52) U.S. Cl. 187/414

(57) ABSTRACT

A space elevator and method of construction of the same that allows a space elevator to be constructed with a single rocket launch by simultaneously sending cables down to earth and away from earth via a construction satellite. When the earthbound cable reaches the surface, additional cable of gradually increasing cross section is fed from the surface of the earth to finish the construction. The finished space elevator uses moving cables to transport simplified elevator cars into space, thereby greatly increasing the throughput of cargo into space compared to prior art and previous designs.

### BACKGROUND OF THE INVENTION

The present invention relates to moving goods and people from the surface of the earth to outer space. Currently, all loads sent into space are transported via chemical rockets. Not only do chemical rockets present serious safety concerns with the vast amounts of fuel and oxidizer, but the cost of sending cargo into space via chemical rockets is very expensive. It can cost $5000/kg or more to put cargo into low earth orbit, and $20,000/kg to put cargo into geostationary orbit.

An alternative to chemical rockets was put forth in 1960 by Yuri Artsutanov with the idea of a space elevator. The mathematical fundamentals for a space elevator were documented in 1975 by Jerome Pearson. However, to date, the limiting factor that has kept a space elevator from being built has been the lack of suitable material with which to build the elevator cable. Yet, recent developments with nanotubes and other allotropes and compounds of carbon or boron indicate that the lack of suitable materials will no longer be a problem in the not-too-distant future.

Even if suitable cable materials had been available in the past, the prior art and previous designs may still have kept a space elevator from being built. Existing designs have had very high costs for construction, and would not be very practical or economical to operate. Prior art required massive accumulations of materials in space from multiple rocket launches, and the slow build-up of the space elevator by the means of climbers once a “seed” cable has reached the earth. In addition, the throughput of cargo, per year, into space using climbers on a finished space elevator would be low.

Cable climbers using laser beams as an energy source have become the accepted idea for building and operating a space elevator. In fact, NASA has so thoroughly accepted the idea of space elevator climbers that it has offered a two million dollar prize for a top performing climber with its Elevator 2010 Challenge.

However, laser powered climbers are, at best, only one or two percent efficient. Therefore 50 to 100 times the actual energy needed would be required each time a climber goes up a space elevator. Also the motors, wheels, and energy conversion equipment for a climber comprise a large portion of the mass of the climber, which limits the cargo capacity. Therefore, the energy requirements for a climber may be 200 times the actual energy needed to take the cargo alone into space. In addition, climbers are inherently slow due to the power requirements and wheel limitations, and so the initial building and the ultimate operation of the space elevator would be slowed by both the speed and the cargo capacity of the climbers.

Another problem of previous designs is that the incremental cables lifted by the climbers to build the space elevator would always be dragging or sliding against the existing cable. That friction and proximity create a high probability for a snag or tangled cables which would be very difficult to deal with.

Against this background of problematic designs, the inventor has devised novel solutions which will allow the quick and economical construction of a practical space elevator and will insure its widespread acceptance and use.

### SUMMARY OF THE INVENTION

It is therefore the objective of the present invention to provide a novel method and apparatus to quickly transport materials and personnel from the surface of the earth into outer space using substantially less energy and money than has been required heretofore, by means of a practical space elevator. The present invention is a great improvement over prior art for the construction of a space elevator in that it only requires a single rocket launch, regardless of the specific strength of the space elevator cables. All subsequent work is done by feeding cables from the ground. No sliding of cables against cables is ever needed.

The construction of a space elevator according to the present invention will be faster, simpler and less costly than by using any prior art. Also, the operation of the present invention will allow a higher throughput of cargo to space, a lower energy use, and a faster time to orbit than with any previous space elevator designs. The cables of the present invention would move in a big loop from earth to geostationary orbit, and would provide an almost 100% efficient means of energy transfer. Huge motor/generators on the ground would power loads up the space elevator faster than any prior designs could ever do, and they would regeneratively recoup any energy from slowing down or descending loads.

The present invention only requires a single rocket launch for construction, and the build-up of the cable strength would be many times faster than could be achieved by climbers. Also, after a space elevator of the present invention was constructed, the throughput of cargo into space per year would be many times greater than a space elevator using climbers.

For passenger travel into space, the present invention would require almost zero net energy, as the energy expended when the passengers went up would be recouped when they came back down. In addition, the fast transit time through the Van Allen radiation belts would mean less shielding requirements for passenger travel. Cargo into space would generally not come back down, but the elevator car that delivered it would come down, meaning that the net energy expended would only be the actual energy needed to raise the cargo itself.

The present invention would provide a significant improvement over the prior art in many aspects.

### BRIEF DESCRIPTION OF THE DRAWINGS

FIG. 1 is a diagram showing one embodiment of the present invention of a space elevator, with a single moving cable extending from the earth to geostationary orbit; and

FIG. 2 illustrates a construction satellite used by the present invention in initiating the building of a space elevator; and

FIG. 3 is a diagram of the construction process for building a space elevator as taught by the present invention; and

FIG. 4 illustrates a method of lifting a space elevator pulley into space as taught by the present invention; and

FIG. 5 is a diagram of the present invention of a space elevator composed of multiple loops of moving cables between earth and geostationary orbit; and

FIG. 6 illustrates the support, connection, and drive mechanism between two pulleys of a space elevator of the present invention with multiple loops; and

FIG. 7 illustrates the transfer of a space elevator car of the present invention from one loop to another; and

FIG. 8 is a diagram showing the method of construction of a space elevator of multiple loops as taught by the present invention.

### DETAILED DESCRIPTION OF THE INVENTION

The following description is provided to enable any person skilled in the art to make and use the present invention, and sets forth the best modes contemplated by the inventor for using his invention. Variations to this description however, will be readily apparent to those skilled in the art, since only the generic principles of the present invention have been defined herein.

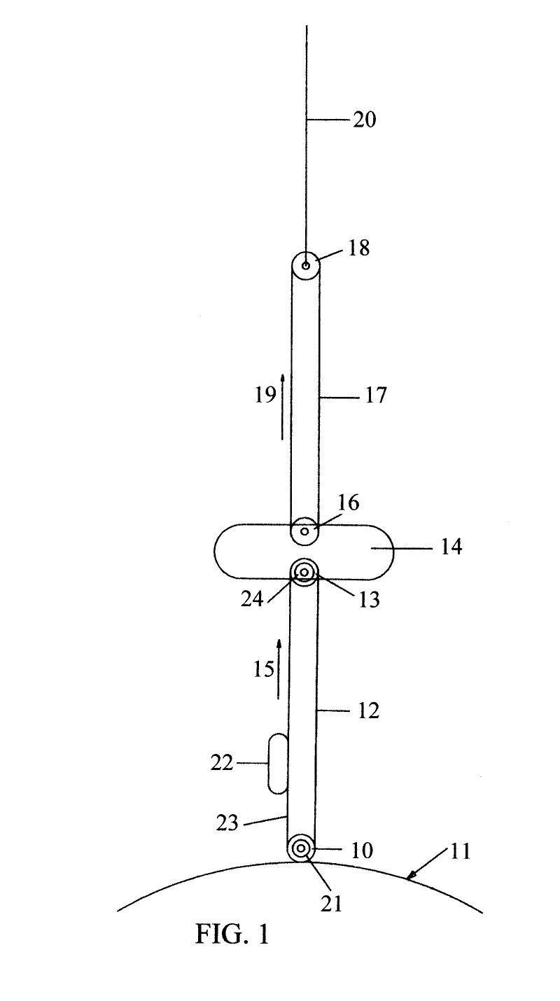

Referring now to FIG. 1, the space elevator of the present invention includes a pulley 10, securely fixed to the surface of the earth 11, at a location near the equator. A belt 12, is wrapped around pulley 10, and extends in a great loop from the surface 11 to a second pulley 13, located in space station 14, in geostationary orbit. Belt 12 rotates in the direction shown by arrow 15, and belt 12 is generally kept continually rotating in order that the Coriolis force, from the rotation of the earth, keeps the two opposite sides of the belt apart so that they cannot become entangled. Also located in space station 14 is third pulley 16, to which second long belt 17 is attached. Belt 17 extends many thousands of kilometers beyond geostationary orbit and ends at a fourth pulley 18. The rotation of belt 17 is shown by arrow 19, and is in the same direction as the rotation of belt 12 in order that the Coriolis force also keeps both sides of belt 17 apart. Attached to pulley 18 is a counterweight cable 20, which extends many thousands of kilometers farther from the earth than pulley 18 and provides the centrifugal force, via the rotation of the earth, to counter the weight of belt 12, as well as provide initial tension on belt 12.

The operation of the present invention, as depicted in FIG. 1, is as follows: Regenerative braking motor 21 on pulley 10 stops the rotation of belt 12, and a load 22 is clamped to the rising side of belt 12, load 22 having a weight less than the initial tension on one side of belt 12. As belt 12 is many thousands of kilometers long, and has a significant amount of stretch in it, any acceleration of pulley 10 will not directly transfer motion to lift load 22. However, as pulley 10 is forced to rotate by motor 21, that movement takes the tension off of belt 12 in the area 23 between pulley 10 and load 22, which then allows the tension in belt 12 above load 22 to start lifting load 22. As pulley 10 accelerates, so will load 22 accelerate until the desired speed of load 22 is achieved. The fact that belt 12 quickly stops to allow load 22 to be attached will not allow the two sides of belt 12 to come together to risk entanglement, due to the fact that the oscillation period of the two sides of belt 12 is measured in hours, due to the extreme length. Therefore, stopping belt 12 long enough to attach or detach loads would only induce slight ripples in the overall path of belt 12, but would not allow the two sides of belt 12 to get close enough to risk entanglement.

Continuing with the operation of the present invention, as depicted in FIG. 1, load 22 would rise with the rotational movement 15 of belt 12 until it neared space station 14, at which point braking motor 24, on pulley 13, would slow belt 12 to a stop, and load 22 would be unclamped from belt 12. The cargo of load 22 would then be accessible for unloading at space station 14. Alternatively, if a lower earth orbit was the final destination of load 22, then load 22 would be unclamped from belt 12 at a lower altitude. If the final destination of load 22 was an interplanetary location, then load 22 would be transferred and clamped to belt 17 at space station 14, in like manner as it had been clamped to belt 12 at the surface of the earth. As the distance of load 22 from the earth increased by the movement 19 of belt 17, the rotation of the earth would cause the tangential velocity of load 22 to increase. When the tangential velocity of load 22, coupled with the orbital velocity of the earth, was sufficient to reach the desired interplanetary location, load 22 would then be unclamped from belt 17 with the required trajectory.

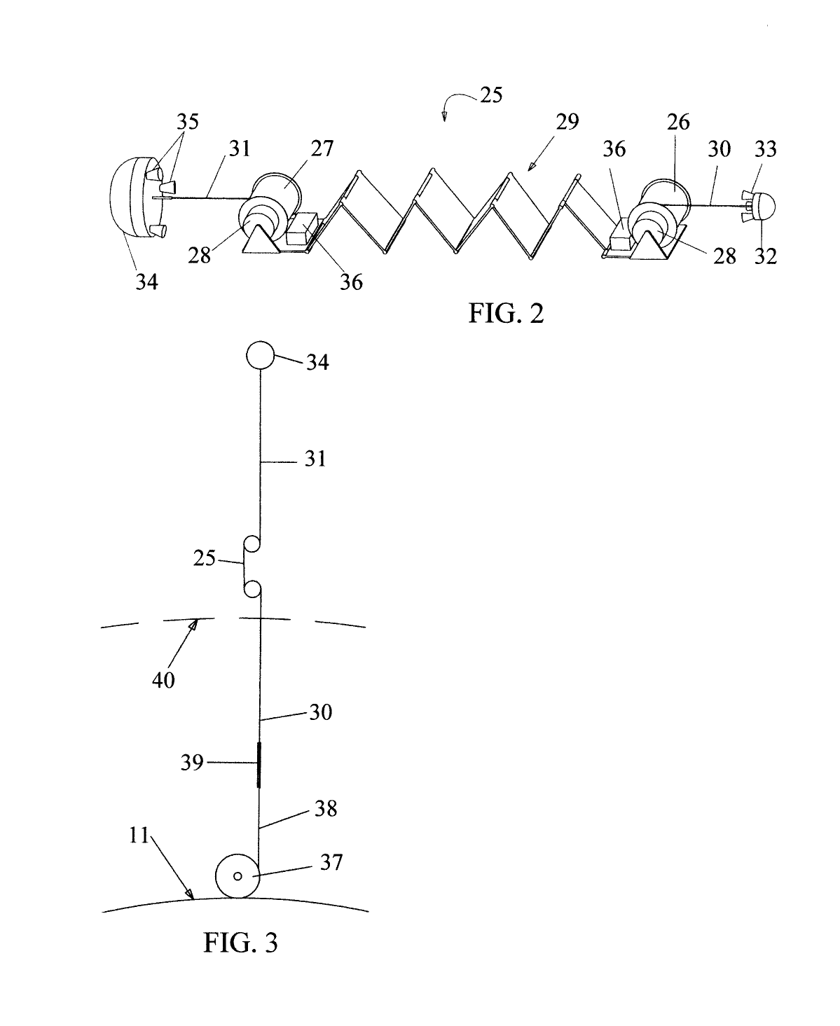

The space elevator as depicted in FIG. 1 can be quickly and easily constructed using a construction satellite 25, as illustrated in FIG. 2. Satellite 25 has two reels of cable, reel 26, and reel 27. Each of these reels is rotationally connected to a motor/generator 28 that either drives or brakes the rotation of the respective reel, depending on whether it is operating as a motor or generator. Between reels 26 and 27 is an extendable satellite frame 29, needed to provide distance between the two reels, so that the extreme tension from cables 30 and 31 will always be very nearly tangential to the reels, with only a very small axial force. In addition, extendable frame 29 is covered by photovoltaic cells to power satellite 25. Attached to cable 30 is earth-bound load 32, initially guided by thrusters 33; and attached to cable 31, is counterweight 34, guided by thrusters 35. Control centers 36 provide both the electronic controls needed as well as high power resistive elements to dissipate the energy generated by generators 28.

The operation of the present invention, as illustrated in FIG. 2 is a follows: Satellite 25 is placed in geostationary orbit above the desired location of the space elevator base station. Once in that orbit, satellite 25 opens its extendable frame 29 to change from a compact rocket load to the required lengthy satellite. After extending frame 29, satellite 25 would then orient itself, with cable 30 pointing toward the earth, and cable 31 pointing away from earth. At that point, thrusters 33 on earth-bound load 32 would gently fire, and motor 28 would simultaneously begin to unwind reel 26, sending load 32 on a trajectory towards earth. At the same time, thrusters 35 on counterweight 34 would fire, and cable 31 from reel 27 would begin to unwind, sending counterweight 34 on a trajectory away from the earth. Once thrusters 33 and 35 got their respective loads up to a modest speed of perhaps 50 m/s, they would no longer be needed. The inertia of load 32 and counterweight 34 would keep them going, and the tangential velocity imparted to cables 30 and 31 by the rotation of their respective reels 26 and 27 would keep load 32 and counterweight 34 moving in their respective directions, with cable following them.

After a few hundred kilometers of cable were reeled out from reels 26 and 27 the tidal forces would be sufficient to keep the cables aligned with the earth. After a few thousand kilometers were reeled out, motors 28 would have to become generators to hold back the tension created by the gravitational force pulling on load 32 and the centrifugal force pulling on counterweight 34.

Incidentally, it would probably be advantageous from an engineering, manufacturing, and operational standpoint to have reels 26 and 27, with their motor/generators 28, identical. The mass of counterweight 34 could be easily adjusted so that the necessary length of cable on reel 27 was exactly the same as the length of cable on reel 26.

As load 32 and counterweight 34 got farther and farther away from satellite 25, the center of gravity of the whole system could easily shift away from geostationary orbit, causing satellite 25 to drift with respect to the location of the space elevator ground station on earth. In order to keep the center of gravity at the desired geostationary location, a ground-based station-keeping control center would monitor the position of satellite 25 as cables 30 and 31 were being extended. Signals from that control center would speed up or slow down reels 26 or 27 as needed in order to always maintain the center of gravity in the appropriate geostationary location.

With load 32 approaching earth, and counterweight 34 approaching its specified distance, the tension on cables 30 and 31 would increase to very high levels, requiring the dissipation of a large amount of energy generated by the generators 28. In fact, the last few thousand kilometers may require a slowing of the cable speed so as to not exceed the capacity of the generator and the power dissipation resistors. When load 32 arrived at the surface of the earth, it would have expended its propellent, and would just be an empty shell, therefore it would not weigh much. However, it would be brightly colored and carry a transmitter to signal its presence as it got close to the ground.

After load 32 reached the surface of the earth it would be located and transported to the designated space elevator base station. At that time, the tension on cable 30, at the surface, would essentially be the weight of the empty shell of load 32. Load 32 would then be removed from cable 30, and the reels 26 and 27 of satellite 25 would be locked in place, as the work of satellite 25 would be finished.

Referring now to FIG. 3, cable 38 from reel 37 at the base station on earth 11 would be attached via splice 39 to cable 30. The tension on cable 30 that was originally supporting load 32 would then start pulling on cable 38. The cross sectional size of cable 38 would be the same as the size of cable 30, because even though there would be a little initial tension on cable 30, that tension would not be sufficient to lift a larger cable very high. As reel 37 began to unwind, the tension on cable 30 would pull up any amount of cable 38 that was unwound, thereby increasing the distance of counterweight 34 from the surface of the earth. That increased distance would increase the tension on cable 30 due to the increased centrifugal force on the counterweight. Also, the additional cable 38 would move disabled satellite 25 to a distance farther out than geostationary orbit 40, causing satellite 25 to become a counterweight itself.

The increased tension caused by the increased length of cable 38 can be calculated by knowing the mass of counterweight 34, the mass of disabled satellite 25, and the mass per unit length of the cables 30, 31, and 38. The centrifugal force minus the gravitational force of each segment can be added to determine the net tension in cable 38. When cable 38 has been extended sufficiently to produce the desired tension level, cable 38 can then be increased in cross sectional area, and fed out towards space. When an appropriate tension level was reached, the more massive cable 38 could then be pulled all the way out to geostationary orbit without the space elevator losing tension, so that more cable 38 could always be pulled up. That same process could then be continued with progressively larger cables.

Eventually, with enough additional cable 38 fed up from earth, counterweight 34 would get far enough from the surface of the earth that its centrifugal force would exceed the strength of cables 30, 31 and the smaller section of cable 38 that support it. However, before these cables were allowed to be overstressed, the mass of counterweight would need to be decreased in order to reduce that centrifugal force. The majority of the mass of counterweight 34 could be in liquid form so that the mass could be gradually released as its distance from the earth increased. However, the time would come when even the empty shell of counterweight 34 would have to be jettisoned. Also, disabled satellite 25 would eventually get far enough from earth that its centrifugal force would require it to be jettisoned also, in order to keep from over-stressing the cables 30 and 38.

After counterweight 34, and satellite 25 were jettisoned, there would only be cables pulling cables into space. There would be no space-based mechanisms, controls, reels, satellites or other devices needed to finish the construction of the space elevator. However, even sections of the cables themselves would have to be jettisoned when they got so far from earth that their centrifugal force began to exceed the allowable stress limit. Those sections of cables could be jettisoned by a designed weak point where the cable would purposely break at a certain point once the stress got to a certain level, or by radio-controlled pyrotechnic devices periodically attached to the rising cable.

With cables pulling cables, the space elevator could be gradually increased in size until the design requirements of strength and initial tension were met. However, the end result would simply be a single cable extending from earth to over 150,000 km above the earth, not the rotating elevator belts as shown in FIG. 1. This would be resolved by pulling the appropriate pulleys into space.

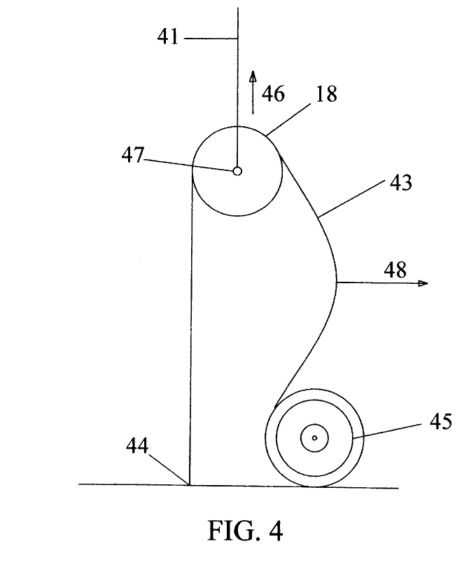

Referring now to FIG. 4, the finished space elevator cable 41 would be attached to the axle 47 of pulley 18, allowing axle 47 to spin freely, with belt 43 wrapped around pulley 18 and firmly attached to the surface at point 44. The other end of belt 43 would be fed from reel 45 as cable 41 pulled pulley 18 up into space in direction 46. As pulley 18 moved upward towards space, belt 43 would be forced to unwind from reel 45 at twice the speed of pulley 18. That upwards velocity, coupled with the rotation of the earth, would create a Coriolis force 48 on belt 43 that would keep the rising side of belt 43 separated from the stationary side. Pulley 18 would continue to be raised by cable 41 until the distance between the earth and pulley 18 was the same as the distance between pulley 16 and pulley 18 in FIG. 1. At that point, the fixed end 44, of belt 43, would be spliced to the rising end of belt 43 around pulley 16, forming belt 17, as shown in FIG. 1. The same process illustrated by FIG. 4 would then be repeated, with pulley 16 and space station 14 attached to pulley 13, with the belt material that becomes belt 12 being fed by a large reel similar to reel 45. When space station 14, with pulley 13, arrived at it final location, belt 12 would be spliced together around reel 10, and the space elevator would be completed.

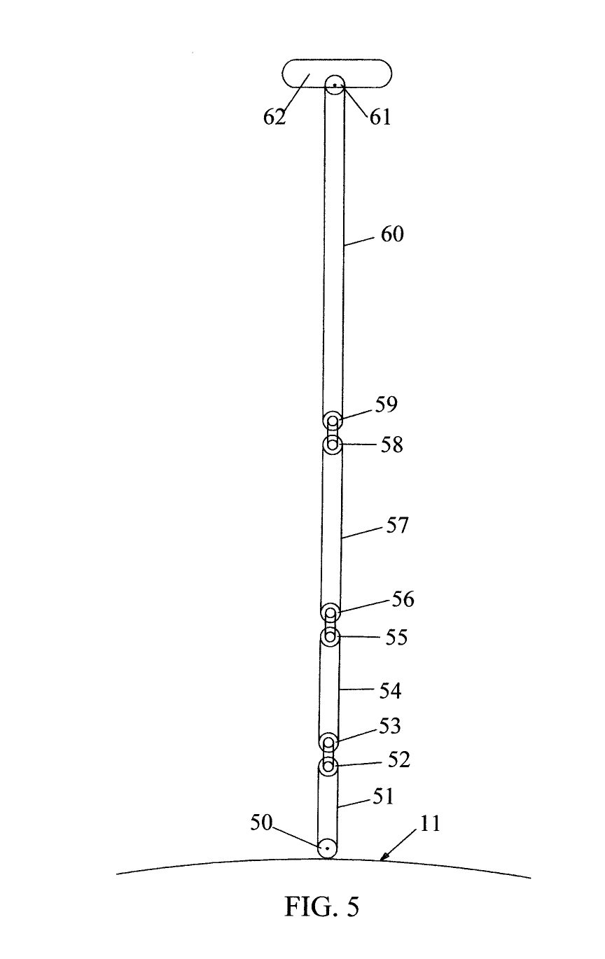

In FIG. 5, the present invention is diagrammed for a space elevator composed of multiple loops of moving belts between earth and geostationary orbit. This embodiment of the present invention is needed if the specific strength of the belt material is not strong enough to support its own weight between earth and geostationary orbit. An example, with numbers, will be shown for a case where the specific strength of the material is less than 20×10⁶ N-m/kg.

The load on a segment of space elevator cable can be calculated as follows: The gravitational force dF on a section dr of cable of mass λ/m is:

$$dF = \frac{{GM}_{e} λ dr}{{r}^{2}}$$

Where G is the gravitation constant, Mₑ is the mass of the earth, and r is the distance from the center of the earth.

If we had a cable stretched from point A to point B, in a radial line above the surface of the earth, there would be a total force from gravity on the cable:

$$F = {\int }_{A}^{B} \frac{G {M}_{e} λ d r}{{r}^{2}} = \frac{G {M}_{e} λ}{A} - \frac{G {M}_{e} λ}{B} \qquad ( 1 )$$

There is also centrifugal force on the cable that tends to counter the gravitational force:

F=mω²r (ω²=5.317×10⁻⁹ for the earth's rotation.)

So, for a segment of cable of mass λdr, dF=ω²λrdr. Integrating this we get:

$$F = {\int }_{A}^{B} {ω}^{2} λ r d r = \frac{λ {ω}^{2} {B}^{2}}{2} - \frac{{λω}^{2} {A}^{2}}{2} \qquad ( 2 )$$

Subtracting equation 2 from equation 1, we have the net force on a segment of cable that extends from point A to point B:

$$F = \frac{G {M}_{e} λ }{A} - \frac{G {M}_{e} λ}{B} - \frac{{λω}^{2} {B}^{2}}{2} + \frac{{λω}^{2} {A}^{2}}{2} \qquad ( 3 )$$

Using equation 3 the load on any of the belts of a multiple loop space elevator can be calculated. The calculated loads for the example of a material with a specific strength of less than 20 MN-m/kg are shown in the following description of FIG. 5.

Referring now to FIG. 5, a pulley 50, is attached to the surface of the earth 11, located at a distance of 6.38 Mm from the center of the earth, around which is wrapped a belt 51, extending upward to pulley 52, located 8.7 Mm from the center. This length of belt puts a load of 16.6 MN-m/kg on belt 51 at pulley 52. Attached to pulley 52 is another pulley, 53, around which belt 54 is wrapped and extended upward to pulley 55, at a distance of 11.1 Mm. Belt 54 has twice the cross section of belt 51. The load on belt 54 is 18.1 Mn-m/kg with its own weight plus the weight of belt 51. Connected to pulley 55 is another pulley, 56, around which belt 57 is wrapped and extended up to pulley 58, located at a distance of 18 Mm. Belt 57 has six times the cross section of belt 51. The load on belt 57 is 19.3 Mn-m/kg with its own weight plus the weights of belts 54 and 51. Connected to pulley 58 is another pulley, 59, around which belt 60 is wrapped and extended up to pulley 61, located in space station 62, at a distance of 42.2 Mm, which is the height of geostationary orbit. Belt 60 has eleven times the cross section of belt 51, The load on belt 60 is 18.7 Mn-m/kg with its own weight plus the weights of belts 57, 54 and 51. Additional belts (not shown) would extend upward from space station 62 to a counterweight cable in order to maintain the appropriate tension in the space elevator.

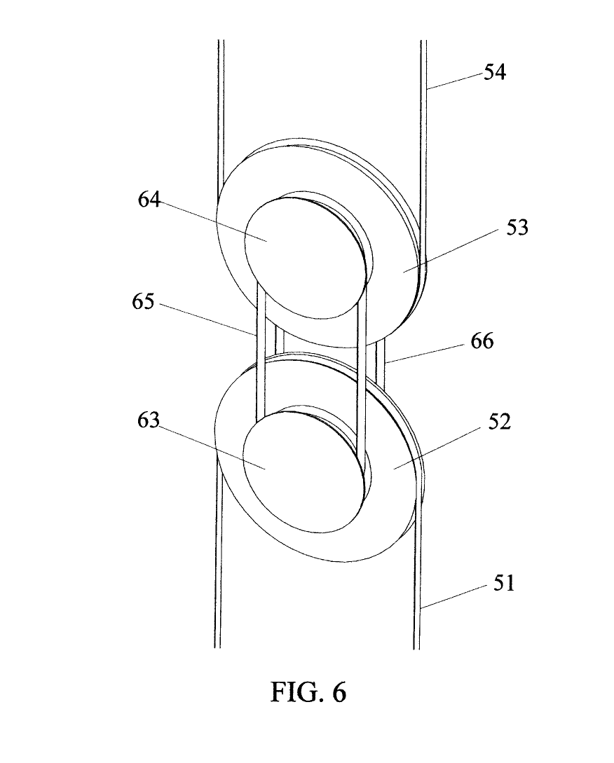

The support, connection, and drive mechanism between pulleys 52 and 53 of the present invention is illustrated in FIG. 6: A pulley, 63, is rigidly attached to, and concentric with, pulley 52, as is pulley 64 attached to, and concentric with, pulley 53. A similar set of pulleys, not shown, are attached to the back sides of pulleys 52 and 53. A belt 65 is stretched between pulleys 63 and 64, and a similar belt 66 is stretched between the pulleys on the back sides of pulleys 52 and 53. Belts 65 and 66 would serve the multiple purposes of providing the load-carrying support, the bearing surfaces, and the drive system between pulleys 52 and 53. As belt 51 rotated, the present invention would also cause belt 54 to rotate synchronously with belt 51. With the other pairs of pulleys of the present invention all having similar configurations, the bottom belt 51 of the present invention would drive all of the other belts of the space elevator.

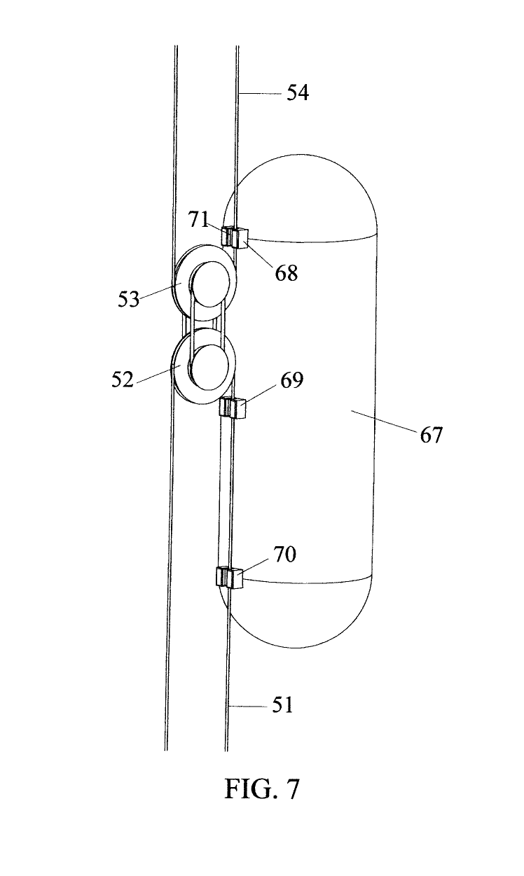

Referring now to FIG. 7, an elevator car of the present invention is shown crossing over a pair of pulleys of a multiple loop space elevator of the present invention. The elevator car 67 has three clamping mechanisms, shown as 68, 69, and 70, the distance between adjacent clamps being greater than the distance between pulleys 52 and 53, and clamping mechanisms 68, 69, and 70 each providing a firm grip to the elevator belts 51 or 54. Each of the clamping mechanisms 68, 69, and 70 would have a clamp opening 71, which would allow a pulley, such as pulley 52, to pass through when in the unclamped state. As car 67, rising via the movement of belt 51, approached pulley 52, belt 51 would slow down, allowing clamping mechanism 68 to unclamp itself from belt 51. Clamp opening 71 would then allow clamp 68 to pass over pulleys 52 and 53, where it would then be reclamped to belt 54. Next, clamp 69 would unclamp from belt 51 and pass over the pulleys 52 and 53 until it could also reclamp on belt 54. Finally, clamp 70 would follow the same process to transfer itself to belt 54. With at least two clamps always attached to the belts, elevator car 67 would always be stable and secure as it rode the space elevator past the various pulley pairs.

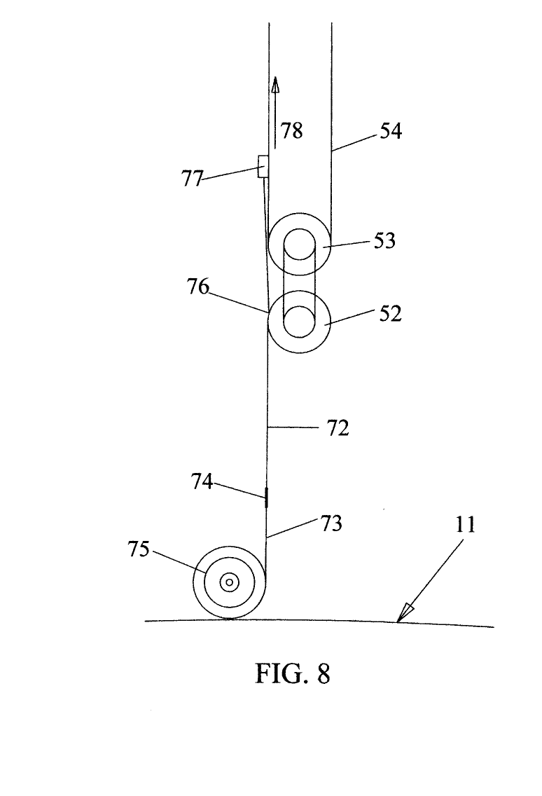

The method of construction of a multiple loop space elevator of the present invention, as diagramed in FIG. 5, will now be revealed. As the strength of the cable material of a multiple loop space elevator is insufficient for a space elevator to be constructed via the method shown in FIGS. 2 and 3, a different construction method is required. An initial construction satellite, analogous to satellite 25 of FIG. 2, would feed out multiple belts in the form shown in FIG. 5, but with one exception. The exception is that although the ratio of belt sizes would be the same as taught by the present invention of FIG. 5, the bottom belt 51 would be replaced by a single cable 72, as shown in FIG. 8, and the belt sizes would be very small compared to the desired finished size.

Continuing on with FIG. 8, cable 72 would initially be lowered to the surface in like manner as was cable 30 in FIG. 3, cable 72 also having a small initial tension due to a weight on the end. Cable 72 would then be attached to a new cable 73, of the same size as cable 72, via splice 74, cable 73 being fed from reel 75. Reel 75 would then feed out additional cable 73, compelling the entire system to move further out into space, to increase the tension on cable 72, at pulley 52, to the maximum allowable tension. When the maximum tension was achieved, cable 72 would be wrapped around capstan 76 on pulley 52, and clamp 77 would attach the end of cable 72 to belt 54, which would begin to rise in direction 78. The slight tension provided on cable 72 by belt 54 would engage the grip of capstan 76, and cable 72 would begin to rise. The weight of cable 72, from the earth to the pulleys, would be supported by the grip of capstan 76, as the necessary additional cable 73 was being fed from reel 75. Therefore, as cable 72 was lifted up by belt 54, it would essentially only have to carry the weight of the cable above the capstan.

As clamp 77, along with cable 72, was lifted by belt 54, it would eventually reach pulley 55, as seen in FIG. 5. At that point, a mechanism would transfer clamp 77 and cable 72 to be wrapped around a capstan on pulley 55, and then clamp 77 would be reclamped onto belt 57. Then cable 72 would rise with belt 57, with the weight of cable 72 between pulleys 55 and 53 being supported by the capstan on pulley 55. A similar transfer would occur when clamp 77 reached pulleys 58 and 59, and clamp 77 would reclamp onto belt 60, which would carry cable 72 all the way up to space station 62 at geostationary orbit.

As cable 72 initially began to be lifted above the height of pulley 52, as diagrammed in FIG. 8, one side of cable 54 would have more mass than before, and the weight of this mass would decrease the overall tension of the space elevator. With the example given above of a space elevator made of material with less than 20 MN-m/kg of specific strength, the end of cable 72 would only rise about 500 km above the height of pulley 52 until the overall tension had decreased sufficiently that a smaller diameter cable 73 would then be required in order to keep the tension from disappearing completely. In the example given, that reduction in cross section be about 36% of the original size of cable 73, in order that the end of cable 72 could be lifted all the way to geostationary orbit without losing the overall tension in the space elevator.

Once cable 72 reached space station 62, reel 75 would continue to feed out more cable 73, and cable 72, followed by cable 73, would be collected on an empty reel in space station 62, until a large mass of cable was accumulated on that reel. Because that mass would be in geostationary orbit, it would not affect the overall tension of the space elevator in any way, as all mass in geostationary orbit has its weight perfectly balanced by its centrifugal force. After a sufficient quantity of cable was accumulated in space station 62, cable 73 would then be cut from the geostationary reel, and the cut end permanently attached to the downward-moving side of belt 60. At about the same time, the other end produced by the cut in cable 73 would be permanently attached to the upward moving side of the belt extending upwards from space station 62. Therefore, new cable from the earth, fed by reel 75, would wrap around belt 60 at the same time that the accumulated cable in station 62 would wrap around the first belt extending above station 62. Thus both belts would be strengthened at the same time, and in a way that would not adversely affect the overall tension of the space elevator. After belt 60 had been strengthened by multiple wraps of cable 73, fed from reel 75, then the end of cable 73 would again be wrapped around the reel in space station 62, and the reel would again start being filled by more cable 73 from reel 75. After that reel was sufficiently full again, then cable 73 would be cut again, and the end transferred down to belt 57, where belt 57 would be strengthened by multiple wraps of cable 73 from reel 75 at the same time that an upper belt, above station 62, was being wrapped by the cable from the space station reel. A similar process would then be used to strengthen belt 54, Also, during this entire construction process, the cross section of cable 73 would be increased as often as the overall tension and the load carrying capacity of cable 73 would allow it.

Therefore, by continuing the above process of wrapping all of the space elevator belts, both above and below space station 62, the entire space elevator could be strengthened as much as was desired. One of the final steps of the construction process would be changing single cable 73 to belt 51, as shown in FIG. 5, to finish the multiple loop space elevator.

Those skilled in the art will appreciate that various adaptations and modifications of the invention as described above can be configured without departing from the scope and spirit of the invention. Therefore, it is to be understood that, within the scope of the appended claims, the invention may be practiced other than as specifically described herein.

What is claimed is:

1. A method of constructing a space elevator whereby a seed cable is extended to the surface of the earth from a satellite, tension is induced in said seed cable, a ground-based cable of substantially the same size as said seed cable is connected to said seed cable and fed up into space by said tension, thereby increasing the distance of the counterweight from earth; and after said tension has increased sufficiently through the feeding of said ground-based cable, a cable of a larger size than said seed cable is then attached to said ground-based cable and fed up into space.

2. The method of claim 1 whereby said satellite, or a portion thereof, is allowed to be pulled further away from earth than geostationary orbit by said tension, thereby becoming a counterweight itself.

3. The method of claim 1 whereby the distance of the counterweight to earth is allowed to increase until the original counterweight cable can no longer safely handle the load of the counterweight, and the counterweight must be jettisoned, leaving the centrifugal force of the cables alone to provide the tension for pulling up more cables.

4. The method of claim 3 whereby the means of jettisoning the counterweight is by radio controlled pyrotechnic devices.

5. The method of claim 1 with the satellite comprising: two or more reels of cables, the cable from one reel attached to a device with means of signaling its presence as it nears the earth, another cable from a second reel attached to, or comprising a counterweight, means for launching and feeding said cables in their respective directions, towards or away from the earth, a satellite frame that is extendable to increase the distance between the reels, and means for dissipating the energy produced by the controlled extension of the cables.

6. The satellite of claim 5 whereby the means for extending the cables and the means for dissipating the energy include a motor/generator for each reel.

7. (canceled)

8. A space elevator comprising: a belt, rotating around a first pulley located at or near the surface of the earth, said belt extending to a second pulley, located at a position substantially above the surface of the earth, said second pulley maintaining tension on said first belt and said first pulley; means for stopping the rotation of said belt, clamping means for clamping a load to said belt after said belt has significantly slowed down or stopped, and means for resuming the rotation of said belt after said load has been clamped to said belt.

9. The space elevator of claim 7 whereby the said second pulley is located at a position between the surface of the earth and 30,000 km above said surface, said second pulley mechanically connected to and being supported by a third pulley, a second belt extending from said third pulley to a fourth pulley substantially higher than said third pulley, said fourth pulley maintaining tension on said second belt, and said second belt having a larger cross section than said first belt.

10. The space elevator of claim 9 whereby the mechanical connection between the said second and said third pulleys is such that any rotation of either pulley is imparted to the other pulley.

11. The space elevator of claim 9 whereby the mechanical connection between adjacent pulleys comprises: a first pulley that is suspended from its fixed axle by two or more belts from the fixed axle of a second pulley, said belts carrying the load and providing the mechanical drive between said pulleys.

12. A method of constructing a space elevator of multiple drive belts comprising: means for temporarily attaching a cable fed from earth to one of the space elevator belts, means for transferring said cable to a second space elevator drive belt, means for removing the tension from said cable after the transfer to said second space elevator drive belt, and means for permanently securing said cable to a space elevator drive belt.

13. The method of claim 12 whereby the means for removing the tension from said cable is a capstan.

14. (canceled)
